(19) United States
(12) Patent Application Publication
(10) Pub. No.: US 2014/0344364 A1
(43) Pub. Date: Nov. 20, 2014

(54) ELECTRONIC DEVICE AND METHOD FOR SHARING COURSE SYLLABUS OF THE ELECTRONIC DEVICE

(71) Applicant: HON HAI PRECISION INDUSTRY CO., LTD., New Taipei (TW)

(72) Inventors: KIA-MING PHUA, New Taipei (TW); SHIH-YING CHEN, New Taipei (TW)

(73) Assignee: HON HAI PRECISION INDUSTRY CO., LTD., New Taipei (TW)

(21) Appl. No.: 14/277,800

(22) Filed: May 15, 2014

(30) Foreign Application Priority Data
May 17, 2013 (TW) 102117480

(51) Int. Cl. H04L 29/08

(52) U.S. Cl. CPC H04L 67/10
USPC 709/204

(57) ABSTRACT

In a method for an electronic device to share a course syllabus, contents of the course syllabus are obtained from an input device of the electronic device. The method generates the course syllabus according to the inputted contents, and sets different sharing authorities of the course syllabus corresponding to different operators. Each sharing authority includes an access authority for accessing contents of the course syllabus. The course syllabus is uploaded to a server connected to the electronic device. When an operator accesses the course syllabus stored in the server, an operation requirement is sent from the electronic device to the server. When the course syllabus is found by the server according to the operation requirement, the method receives contents of the course syllabus sent from the server according to an access authority of the operator.

### FIELD

The subject matter herein generally relates to an electronic device and a method for sharing a course syllabus of the electronic device.

### BACKGROUND

A course syllabus is a teacher's description of topics for a course. A daily course syllabus may be developed by a teacher to guide class instruction. Details will vary depending on the preference of the teacher, subject being covered, and the need and/or curiosity of students. During development of a course syllabus, is often written on papers by an operator (e.g., the teacher), or is stored as an electronic course syllabus in an electronic device. The course syllabus only can be used by the operator who designs it, and cannot share with other operators. Designing the course syllabus repeatedly wastes the time of operators.

### BRIEF DESCRIPTION OF THE DRAWINGS

Implementations of the present technology will now be described, by way of example only, with reference to the attached figures, wherein:

FIG. 1 is a block diagram of one embodiment of a server connected to a plurality of electronic devices.

FIG. 2 is a block diagram of one embodiment of an electronic device including a course syllabus sharing system.

FIG. 3 is a flowchart illustrating one embodiment of a method for sharing a course syllabus of the electronic device of FIG. 2.

FIG. 4 is a chart illustrating one embodiment of contents of the course syllabus of the electronic device.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.” It should be noted that references to the term “comprising,” when utilized, means “including, but not necessarily limited to”; it specifically indicates open-ended inclusion or membership in the so-described combination, group, series and the like.

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

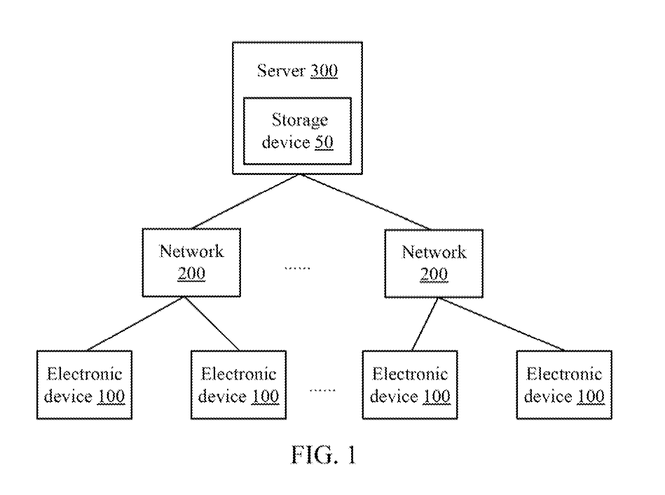

FIG. 1 is a block diagram of one embodiment of a server 300 connected to a plurality of electronic devices 100. In the embodiment, the server 300 connects to the electronic devices 100 through at least one network 200. In the embodiment, each electronic device 100 can be a mobile phone, a notebook computer, a personal digital assistant (PDA), or a computing device, for example. The network 200 can be an Internet, an intranet, an Ethernet, or any other relevant network. The server 300 comprises a storage device 50 that stores various course syllabuses uploaded by the electronic devices 100.

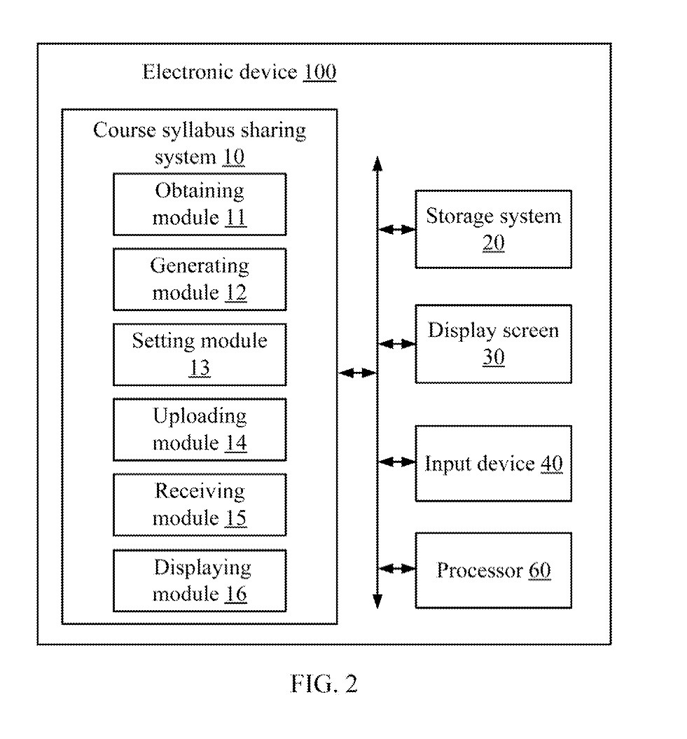

FIG. 2 is a block diagram of one embodiment of an electronic device 100 including a course syllabus sharing system 10. The electronic device 100 further comprises a storage system 20, a display screen 30, an input device 40, and a processor 60. The input device 40 can receive contents of a course syllabus inputted by an operator. In the embodiment, the input device 40 can be a keyboard, or a mouse, for example. The display screen 30 displays the course syllabuses to operators. The processor 60 executes one or more computerized codes and other applications for the electronic device 100, to provide functions of the course syllabus sharing system 10. The storage system 20 stores data of the electronic device 100. In one embodiment, the storage system 20 may be an internal storage device, such as a random access memory (RAM) for temporary storage of information, and/or a read only memory (ROM) for permanent storage of information. In some embodiments, the storage system 20 may also be an external storage device, such as an external hard disk, a storage card, or a data storage medium.

The course syllabus sharing system 10 comprises, but is not limited to, an obtaining module 11, a generating module 12, a setting module 13, an uploading module 14, a receiving module 15, and a displaying module 16. The modules 11-16 comprise computerized codes in the form of one or more programs that are stored in the storage system 20. The computerized codes include instructions that are executed by the processor 60 to provide functions for the modules.

The obtaining module 11 obtains contents of a course syllabus from the input device 40. In the embodiment, the inputted contents of the course syllabus are inputted by an operator using the input device 40, and can be characters, websites, pictures, audio files, and/or video files, for example.

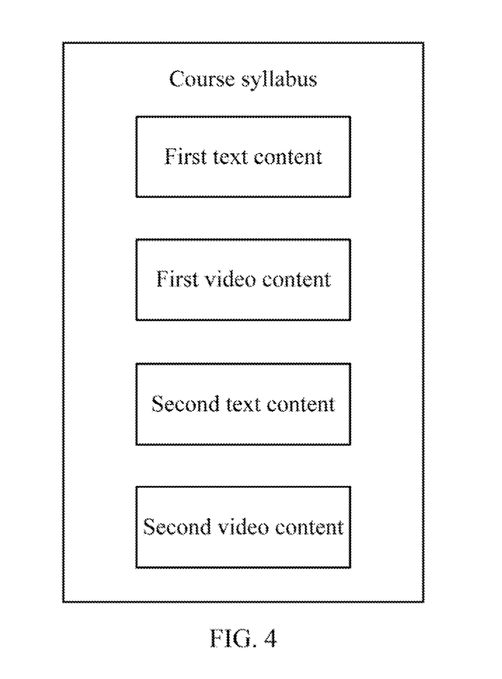

The generating module 12 generates a course syllabus of the electronic device 100 according to the inputted contents. The course syllabus provides a detailed description of the course of instruction for one class, and can comprise teaching materials and resources from a web, for example. In the embodiment, the course syllabus comprises text contents in a text format, audio contents in an audio file format, and/or video contents in a video format. The text contents can be a WORD file, or a PPT file, for example. The audio contents can be a file in a WAV format, or a file in a MP3 format, for example. The video contents can be a file in an AVI format, a file in a 3GP format, or a file in a RMVB format, for example. As shown in FIG. 4, the course syllabus comprises first text content, a first video content, second text content, and a second video content. Each video content can comprise a text content, for example, a description in characters or pictures at a point of time, or a practice at another point of time.

The setting module 13 sets different sharing authorities of the course syllabus corresponding to different operators. In the embodiment, each sharing authority comprises an access authority for accessing a plurality of contents of the course syllabus and an operation authority for editing the plurality of contents of the course syllabus. In the embodiment, the setting module 13 sorts the different operators to a plurality of categories, and sets an access authority and an operation authority for operators of a category.

For example, when an editor of the course syllabus is a teacher (denoted as “teacher A”), a teacher in the same school of the teacher A can view and edit all contents of the course syllabus. A teacher in a different school of the teacher A can access all contents of the course syllabus, but cannot edit the contents of the course syllabus. A student of the teacher A can access part contents of the course syllabus (e.g., the first text content and the first video content shown in FIG. 4), and can edit part contents of the accessed contents (e.g., the first video content shown in FIG. 4).

The uploading module 14 uploads the course syllabus to the server 300. The server 300 stores the course syllabus to the storage device 50.

The receiving module 15 sends an operation requirement from the electronic device 100 to the server 300 when the operator needs to access the course syllabus. The operation requirement is defined to obtain a course syllabus from the course syllabuses stored in the server 300. Each course syllabus corresponds to an operation requirement. For example, when two course syllabuses stored in the server 300 are denoted as course syllabus A and course syllabus B, an operation requirement denoted as operation requirement A can obtain the course syllabus A from the server, and an operation requirement denoted as operation requirement B can obtain the course syllabus B from the server.

In the embodiment, the server 300 finds the course syllabus according to the operation requirement, obtains contents of the course syllabus according to an access authority of the operator, and sends the obtained contents to the electronic device 100. Then, the receiving module 15 receives contents of the course syllabus sent from the server 300 according to an access authority of the operator when the course syllabus is found by the server 300 according to the operation requirement. For example, when the student of the teacher A needs to access the course syllabus shown in FIG. 4, the receiving module 15 receives the first text content and the first video content.

The displaying module 16 displays the received contents on the display screen 30, and edits the received contents according to an operation authority of the sent operator. For example, the student of the teacher A can edit the first video content.

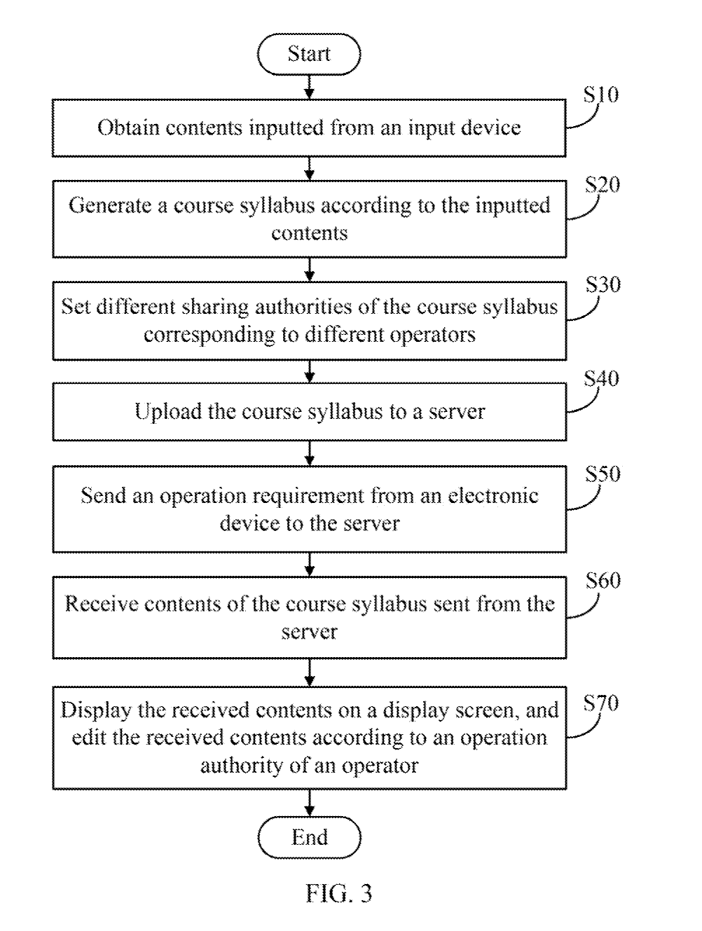

FIG. 3 is a flowchart illustrating one embodiment of a method for sharing a course syllabus of the electronic device 100. Each block shown in FIG. 3 represents one or more processes, methods or subroutines, carried out in the method. Additionally, the illustrated order of blocks is by example only and the order of the blocks can change according to the present disclosure.

In block S10, the obtaining module 11 obtains contents of a course syllabus inputted by an operator from the input device 40.

In block S20, the generating module 12 generates a course syllabus of the electronic device 100 according to the inputted contents of the course syllabus.

In block S30, the setting module 13 sets different sharing authorities of the course syllabus corresponding to different operators. In the embodiment, each sharing authority comprises an access authority for accessing a plurality of contents of the course syllabus and an operation authority for editing the plurality of contents of the course syllabus. In the embodiment, the setting module 13 sorts the different operators to a plurality of categories, and sets an access authority and an operation authority for operators of a category.

In block S40, the uploading module 14 uploads the course syllabus to the server 300.

In block S50, the receiving module 15 sends an operation requirement of an operator to the server 300 when the operator needs to access the course syllabus. The server 300 finds the course syllabus according to the operation requirement, obtains contents of the course syllabus according to an access authority of the operator, and sends the obtained contents to the electronic device 100.

In block S60, the receiving module 15 receives the contents of the course syllabus sent from the server 300 according to the access authority of the operator when the course syllabus is found by the server 300 according to the operation requirement.

In block S70, the displaying module 16 displays the received contents on the display screen 30, and edits the received contents according to an operation authority of the operator.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for sharing a course syllabus of an electronic device, the method comprising:
obtaining contents of the course syllabus inputted from an input device of the electronic device;
generating the course syllabus of the electronic device according to the inputted contents;
setting different sharing authorities of the course syllabus corresponding to different operators, wherein each sharing authority comprises an access authority for accessing a plurality of contents of the course syllabus;
uploading the course syllabus to a server connected to the electronic device;
sending an operation requirement from the electronic device to the server when the course syllabus stored in the server is accessed by an operator; and
receiving contents of the course syllabus sent from the server according to an access authority of the operator when the course syllabus is found by the server according to the operation requirement.

2. The method as described in claim 1, wherein each sharing authority further comprises an operation authority for editing the plurality of contents of the course syllabus.

3. The method as described in claim 1, further comprising:
displaying the received contents on a display screen of the electronic device; and
editing the received contents according to an operation authority of the operator.

4. The method as described in claim 1, wherein the inputted contents of the course syllabus comprise characters, websites, pictures, audio files, and/or video files.

5. The method as described in claim 1, wherein the course syllabus comprises text contents in a text format, audio contents in an audio file format, and/or video contents in a video format.

6. The method as described in claim 1, wherein the sharing authorities of the course syllabus are set by:
sorting the different operators to a plurality of categories; and
setting an access authority and an operation authority for operators of a category.

7. An electronic device for sharing a course syllabus, the electronic device connecting to a server, the electronic device comprising:
an input device;
at least one processor; and
a computer-readable storage medium storing one or more programs, which when executed by the at least one processor, causes the at least one processor to:
obtain contents of the course syllabus inputted from the input device;
generate the course syllabus of the electronic device according to the inputted contents;
set different sharing authorities of the course syllabus corresponding to different operators, wherein each sharing authority comprises an access authority for accessing a plurality of contents of the course syllabus;
upload the course syllabus to the server;
send an operation requirement from the electronic device to the server when the course syllabus stored in the server is accessed by an operator; and
receive contents of the course syllabus sent from the server according to an access authority of the operator when the course syllabus is found by the server according to the operation requirement.

8. The electronic device as described in claim 7, wherein each sharing authority further comprises an operation authority for editing the plurality of contents of the course syllabus.

9. The electronic device as described in claim 7, wherein the one or more programs further cause the at least one processor to:
display the received contents on a display screen of the electronic device; and
edit the received contents according to an operation authority of the operator.

10. The electronic device as described in claim 7, wherein the inputted contents of the course syllabus comprise characters, websites, pictures, audio files, and/or video files.

11. The electronic device as described in claim 7, wherein the course syllabus comprises text contents in a text format, audio contents in an audio file format, and/or video contents in a video format.

12. The electronic device as described in claim 7, wherein the one or more programs further cause the at least one processor to:
sort the different operators to a plurality of categories; and
set an access authority and an operation authority for operators of a category.

13. A non-transitory computer readable storage medium having stored thereon instructions that, when executed by a processor of an electronic device, causes the electronic device to perform a method for sharing a course syllabus, the method comprising:
obtaining contents of the course syllabus inputted from an input device of the electronic device;
generating the course syllabus of the electronic device according to the inputted contents;
setting different sharing authorities of the course syllabus corresponding to different operators, wherein each sharing authority comprises an access authority for accessing a plurality of contents of the course syllabus;
uploading the course syllabus to a server connected to the electronic device;
sending an operation requirement from the electronic device to the server when the course syllabus stored in the server is accessed by an operator; and
receiving contents of the course syllabus sent from the server according to an access authority of the operator when the course syllabus is found by the server according to the operation requirement.

14. The non-transitory computer readable storage medium as described in claim 13, wherein each sharing authority further comprises an operation authority for editing the plurality of contents of the course syllabus.

15. The non-transitory computer readable storage medium as described in claim 13, wherein the method further comprises:
displaying the received contents on a display screen of the electronic device; and
editing the received contents according to an operation authority of the operator.

16. The non-transitory computer readable storage medium as described in claim 13, wherein the inputted contents of the course syllabus comprise characters, websites, pictures, audio files, and/or video files.

17. The non-transitory computer readable storage medium as described in claim 13, wherein the course syllabus comprises text contents in a text format, audio contents in an audio file format, and/or video contents in a video format.

18. The non-transitory computer readable storage medium as described in claim 13, wherein the sharing authorities of the course syllabus are set by:
sorting the different operators to a plurality of categories; and
setting an access authority and an operation authority for operators of a category.
